(19) United States
(12) Patent Application Publication
(10) Pub. No.: US 2004/0224733 A1
(43) Pub. Date: Nov. 11, 2004

(54) Self retracting and extending antenna for portable communicators

(76) Inventor: Michael Kim, Los Altos, CA (US)

Correspondence Address: Aldo D. Test, DORSEY & WHITNEY LLP, Suite 3400, 4 Embarcadero Center, San Francisco, CA, 94111, US

(21) Appl. No.: 10/431,104

(22) Filed: May 6, 2003

(51) Int. Cl. H04M 1/00

(52) U.S. Cl. 455/575.7; 455/550.1

(57) ABSTRACT

A cell phone or data communicator of the type which includes a main housing which houses the electronics and operating circuits and a keyboard and a hinged cover which is opened to expose the keyboard. The cell phone or communicator includes a self retracting and extending antenna. A mechanism is provided for extending the antenna when the cover is opened and for retracting the antenna into the housing when the cover is closed.

### BRIEF DESCRIPTION OF THE INVENTION

This invention relates generally to antennas for portable cell phone or communicators and more particularly to a self extending and retracting antenna for portable cell phone or communicators.

### BACKGROUND OF THE INVENTION

It is advantageous to reduce the size of portable communicators such as cell phones. Communicators and cell phones with small dimensions can easily be carried in the pocket, purse, briefcase, etc. Presently clamshell cell phones which include a main body which houses the electronics and includes the operating keyboard and a hinged cover which includes a display, etc. Our antennas extends beyond the cell phone body, increasing the overall dimension of the cell phone or communicators. Generally the antenna extends several inches away from the body and includes an extendable wire-like antenna which for better reception is extended by the user when operating the cell phone. In many instances the user forgets to extend the antenna and reception is unsatisfactory. Additionally, the increased size or overall dimensions of the cell phone make it less convenient for storage in pockets, purses, etc.

### OBJECTS AND SUMMARY OF THE INVENTION

It is a general object of the present invention to provide a wireless communicators or cell phone of the clamshell type which includes a foldable display in which the action of unfolding the display automatically extends the antenna and the act of folding the display retracts the antenna into the body of the device whereby the overall dimensions of the cell phone are that of the cell phone body itself.

It is another object of the present invention to provide cell phone which has a self extending and retracting antenna.

The foregoing and other objects of the invention are provided by a clamshell type cell phone or communicators which includes a phone body, a display which is hinged to the body so that it can be folded onto the body when the phone is not in use and unfolded to expose the phone keyboard and present a display characterized in that an extendable antenna is accommodated within the cell phone body and means are provided for automatically extending the antenna when the display is unfolded and for retracting the antenna into the body when the display is unfolded and for retracting the antenna into the body when the display is closed.

### BRIEF DESCRIPTION OF THE DRAWINGS

The foregoing and other objects of the invention will be more clearly understood from the following description when read in conjunction with the accompanying drawings of which:

FIG. 1 is a perspective view of a clamshell type cell phone or communicator with the display unfolded to show the antenna extended;

FIG. 2 is a perspective view of the cell phone with the display folded onto the body to show the antenna in the retracted position;

FIG. 3 is a perspective view of the cell phone of FIG. 1 with the housing partially broken away to show the antenna drive mechanism;

FIG. 4 is a perspective view partially broken away to better show the antenna drive mechanism.

### DESCRIPTION OF PREFERRED EMBODIMENTS

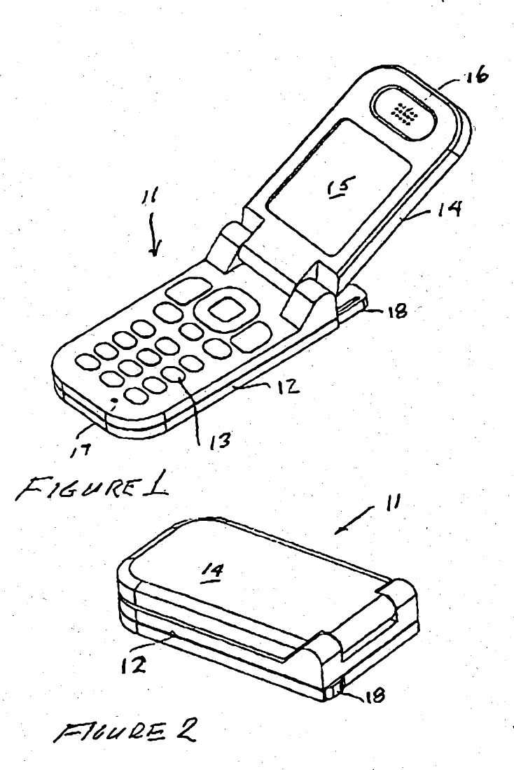

Referring to FIGS. 1 and 2, the cell phone or communicators 11 includes a housing 12 which houses the electronic and operating circuits. The upper surface of the housing including a keyboard for operating the cell phone or communicators. A cover 14 which may include a display 15 and speaker 16 is hinged to the housing. The cell housing includes a microphone 17. A retractable and extendable antenna 18 extends from the housing when the display cover is opened, FIG. 1. A mechanism is provided for extending the antenna when the cover is opened and retracting the antenna when the cover is closed.

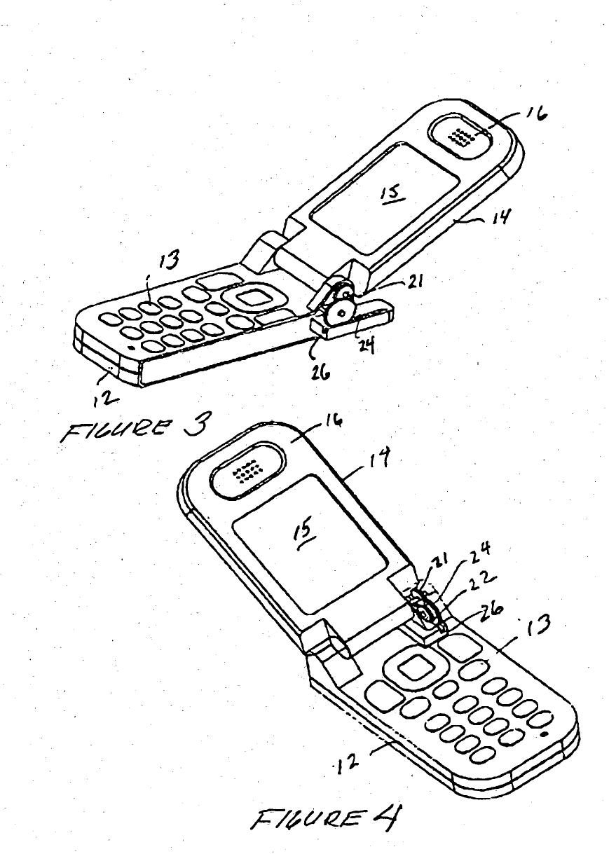

Referring particularly to FIGS. 3 and 4, opening of the cover rotates the drive gear 21 which engages a driven gear 22 (FIG. 4) which rotates the pinion gear 24 which engages a rack 26 coupled to the antenna 18. Thus as the cover is opened, the pinion gear rotates in a counterclockwise direction, extending the antenna. It is of course apparent that by selecting the size of the drive and driven gear and the pinion gears, antennas of various lengths can be extended to any desired length. When the cover is closed, the pinion gear rotates in a clockwise direction, causing the antenna to retract within the housing as shown in FIG. 2. In its retracted position the clamshell phone is compact and easily carried in the pocket, purse or the like and yet when in use the antenna extends automatically upon the opening of the display cover and provides for efficient communication.

What is claimed is:

1. A cell phone or communicator including:
a housing for housing the electronic and operating circuits and having a keyboard;
an antenna adapted to be retracted into the housing when the cell phone or communicator is not in use and extended out from the body when the cell phone or communicator is in use; and
a mechanism for automatically extending the antenna when the cover is opened to use the cell phone or communicator and retract the antenna into the housing when the cover is closed and the cell phone or communicator is not in use.

2. A cell or communicator as in claim 1 in which the mechanism comprises a gear mechanism.

3. A cell phone or communicator as in claim 2 in which the gear mechanism includes at least a drive gear driven by the cover, a driven gear, a pinion gear driven by said driven gear and a rack driven by the pinion gear coupled to the antenna for driving the antenna to the extended and retracted position.
